(19) United States
(12) Patent Application Publication
(10) Pub. No.: US 2006/0163025 A1
(43) Pub. Date: Jul. 27, 2006

(54) Switching controlling apparatus

(75) Inventors: Masashi Hori, Anjo-city (JP); Kiyoshi Kimura, Obu-city (JP); Masaaki Shinojima, Chiryu-city (JP); Tomoyuki Kashiwagi, Chita-gun (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN INC.,, Nishio-city (JP)

(21) Appl. No.: 11/325,498

(22) Filed: Jan. 5, 2006

(30) Foreign Application Priority Data
Jan. 21, 2005 (JP) 2005-14662

(51) Int. Cl. H02P 8/38

(52) U.S. Cl. 192/219.5; 188/156

(57) ABSTRACT

When a detent plate reaches a drive/control stopping position, the torque reducing control for gradually reducing electric power supplied to an electrically operated actuator by duty control is performed and then energizing the electrically operated actuator is stopped. With this, the output torque of the electrically operated actuator is gradually reduced and even when the drive/control stopping position deviates from a detent stabilizing position, the balance between drive/control stopping torque and restoring spring force is gradually released and hence the detent plate does not swing after switching the shift range is finished.

### CROSS-REFERENCE TO RELATED APPLICATION

This application is based on Japanese Patent Application No. 2005-14662 filed on Jan. 21, 2005, the disclosure of which is incorporated herein by reference.

### FIELD OF THE INVENTION

The present invention relates to a switching controlling apparatus for stopping energizing an electrically operated actuator (electric actuator) in a state where a detent mechanism is brought into engagement and relates to an invention suitably applied to a technology for switching the detent mechanism of a shift-range-switching mechanism in an automatic transmission for a vehicle by the output of an electrically operated actuator.

### BACKGROUND OF THE INVENTION

JP-2004-23890A (US-2003/0222617A1) shows a shift-range-switching apparatus for switching the shift-range-switching mechanism of an automatic transmission for a vehicle by the use of the rotational output of an electrically operated actuator.

When a control means for controlling the electrically operated actuator switches a shift range, the control means controls energizing the electrically operated actuator to turn a detent plate in a shift-range-switching mechanism to drive “a parking switching mechanism” coupled to a detent plate and “a manual spool valve of a hydraulic body.” The control means thereby switches an actual range position (actual shift range position) to a target range position (shift range position specified by an occupant, shift range position specified according to driving condition by control means, or the like). Then, when switching the shift range is finished, to reduce power consumption, the control for stopping energizing the electrically operated actuator is performed.

Meanwhile, the shift-range-switching mechanism has a detent mechanism for holding a shift range position (refer to FIGS. 20A and 20B).

The detent mechanism of the shift-range-switching mechanism is constructed of a detent plate (corresponding to a first member) having a plurality of detent grooves corresponding to shift range positions (for example, P, R, N, D) and a detent spring (corresponding to a second member) made of a plate spring and having an engaging part fitted in these detent grooves formed at its tip.

The detent groove is commonly formed in the shape of a letter U or V so as to allow the detent mechanism to be easily released from an engaged-state when the detent plate is driven. Then, the engaging part of the detent spring is constructed in such a manner as to be pressed onto the bottom of the detent groove by the biasing force of the plate spring. Therefore, in a state where the engaging part deviates from the lowest bottom portion of the detent groove, a mechanical force (a force for rotating the detent plate) is applied to the detent plate so as to move the engaging part to the lowest bottom portion of the detent groove.

Therefore, to prevent the detent plate from changing in position after switching the shift range is finished and then energizing the electrically operated actuator is stopped, a position where switching the shift range is finished to stop energizing the electrically operated actuator (hereinafter referred to as “drive/control stopping position”) needs to be in perfect agreement with a position where the detent mechanism is stabilized and stopped (hereinafter referred to as “a detent stabilizing position.”)

However, mechanical parts constructing the shift-range-switching apparatus have individual variations caused in a manufacturing process and the like and hence it is difficult to bring the mechanical “detent stabilizing position” and the electrical “drive/control stopping position” into perfect agreement. Moreover, it is also difficult to predict individual variations and to provide electric motor control with a control constant for canceling the variations.

As described above, there are cases where “a drive/control stopping position” deviates from “a detent stabilizing position” because of mechanical variations and the like.

When “a drive/control stopping position” deviates from “a detent stabilizing position,” just before energizing the electrically operated actuator is stopped (energizing state at the drive/control stopping position), the shift-range-switching mechanism stops in a state where output torque (hereinafter referred to as “drive/control stopping torque”) produced by the electrically operated actuator balances with “restoring spring force” for moving the detent plate to “a detent stabilizing position.” When energizing the electrically operated actuator is stopped in this state, “the drive/control stopping torque” and “the restoring spring force” are thrown out of balance, whereby the detent plate is swung by the action of inertia moment and restoring spring force across a position where the detent mechanism is stabilized.

For this reason, there is presented a problem that the time elapsing after energizing the electrically operated actuator is stopped until the detent plate stops at “the detent stabilizing position” becomes long.

Moreover, because the detent plate swings, the above-mentioned “manual spool valve” also swings in the same manner. When the manual spool valve swings in a hydraulic valve body, the area of an oil passage switched by the manual spool valve changes to cause a delay in the switching of an automatic transmission and the like.

### SUMMARY OF THE INVENTION

The present invention has been made in view of the above-mentioned problems. An object of the present invention is to provide a switching controlling apparatus capable of restricting the swinging of a detent mechanism after stopping energizing an electrically operated actuator.

A control means in a switching controlling apparatus according to the present invention performs the torque reducing control for reducing the output torque of an electrically operated actuator as compared with a normal driving operation by energizing stopping means and then stops energizing the electrically operated actuator when the detent mechanism is brought into an engaged state and the driving position of a first member reaches “a drive/control stopping position” and energizing the electrically operated actuator is stopped.

With this, the output torque of the electrically operated actuator is reduced before energizing the electrically operated actuator is stopped and hence even when “the drive/control stopping position” deviates from “a detent stabilizing position,” an abrupt change does not occur in the balance between “drive/control stopping torque” and “restoring spring force.” For this reason, it is possible to prevent a malfunction that the first member (for example, a detent plate and the like) is swung by the action of inertia moment and restoring spring force.

In this manner, even when “the drive/control stopping position” deviates from “a detent stabilizing position,” the first member is prevented from being swung after energizing the electrically operated actuator is stopped. Therefore, it is possible to shorten the time that elapses after energizing the electrically operated actuator is stopped until the first member stops.

Moreover, it is possible to eliminate a malfunction caused by a phenomenon that the first member swings (for example, a malfunction that when the detent plate swings, the manual spool valve also swings to change the area of an oil passage switched by the manual spool valve).

### BRIEF DESCRIPTION OF THE DRAWINGS

FIG. 1 is a flow chart showing a control example of energizing stopping means (first embodiment).

FIG. 2 is a cross-sectional view of an electrically operated actuator (first embodiment).

FIG. 3 is a system block diagram of a shift-range-switching apparatus (first embodiment).

FIG. 4 is a perspective view of a shift-range-switching mechanism including a parking switching mechanism (first embodiment).

FIG. 5 is a schematic configuration diagram of an electrically operated actuator (first embodiment).

FIG. 6 is a power supply circuit diagram of an electrically operated actuator (first embodiment).

FIG. 7 is a perspective view when viewed from a rear side of a speed reducer (first embodiment).

FIG. 8 is a perspective view when viewed from a front side of a speed reducer (first embodiment).

FIG. 9 is an exploded view in perspective when viewed from a front side of a speed reducer (first embodiment).

FIGS. 10A and 10B are a plan view and a side view showing a state where magnets are magnetized, respectively (first embodiment).

FIG. 11 is a cross-sectional view of a rotor mounted with magnets (first embodiment).

FIG. 12 is a diagram showing the way of mounting magnets (first embodiment).

FIG. 13 is a configuration diagram of Hall ICs (first embodiment).

FIGS. 14A and 14B are output waveform diagrams of A phase, B phase, and Z phase when rotor rotates (first embodiment).

FIG. 15 is a side view showing a position where output angle detecting means is mounted (first embodiment).

FIG. 16 is a diagram showing a linear output Hall IC with resin mold removed from a connector in FIG. 15 (first embodiment).

FIG. 17 is a view when viewed from a direction shown by an arrow “A” in FIG. 16 (first embodiment).

FIG. 18 is a graph showing the relationship between the magnitude of magnetic flux passing through a linear output Hall IC and an output voltage (first embodiment).

FIG. 19A is a graph showing the energizing states of energizing phases of respective exciting coils at the time of a normal driving operation and FIG. 19B is a graph showing the energizing states of energizing phases of respective exciting coils at the time of torque reducing control (first embodiment).

FIGS. 20A and 20B are diagrams showing the principle of swing of a detent plate (first embodiment).

FIG. 21 is a flow chart showing a control example of energizing stopping means (second embodiment).

FIG. 22A is a graph showing the energizing states of energizing phases of respective exciting coils at the time of a normal driving operation and FIG. 22B is a graph showing the energizing states of energizing phases of respective exciting coils at the time of torque reducing control (third embodiment).

FIG. 23A is a graph showing the energizing states of energizing phases of respective exciting coils at the time of a normal driving operation and FIG. 23B is a graph showing the energizing states of energizing phases of respective exciting coils at the time of torque reducing control (modification).

### DETAILED DESCRIPTION OF THE PREFERRED EMBODIMENTS

A switching controlling apparatus of the preferred first embodiment is provided with a detent mechanism including a first member and a second member which can move relatively to each other and capable of mechanically holding the first member and the second member by a structure in which the first member is engaged with the second member by a spring force, an electrically operated actuator for driving the first member, and a control means for controlling energizing this electrically operated actuator to drive and control the first member.

Then, the control means is provided with energizing stopping means that performs a torque reducing control for reducing the output torque of the electrically operated actuator as compared with a normal driving operation when the detent mechanism is brought into an engaged state and the driving position of the first member reaches “a drive/control stopping position and energizing the electrically operated actuator is stopped, and then stops energizing the electrically operated actuator.

### First Embodiment

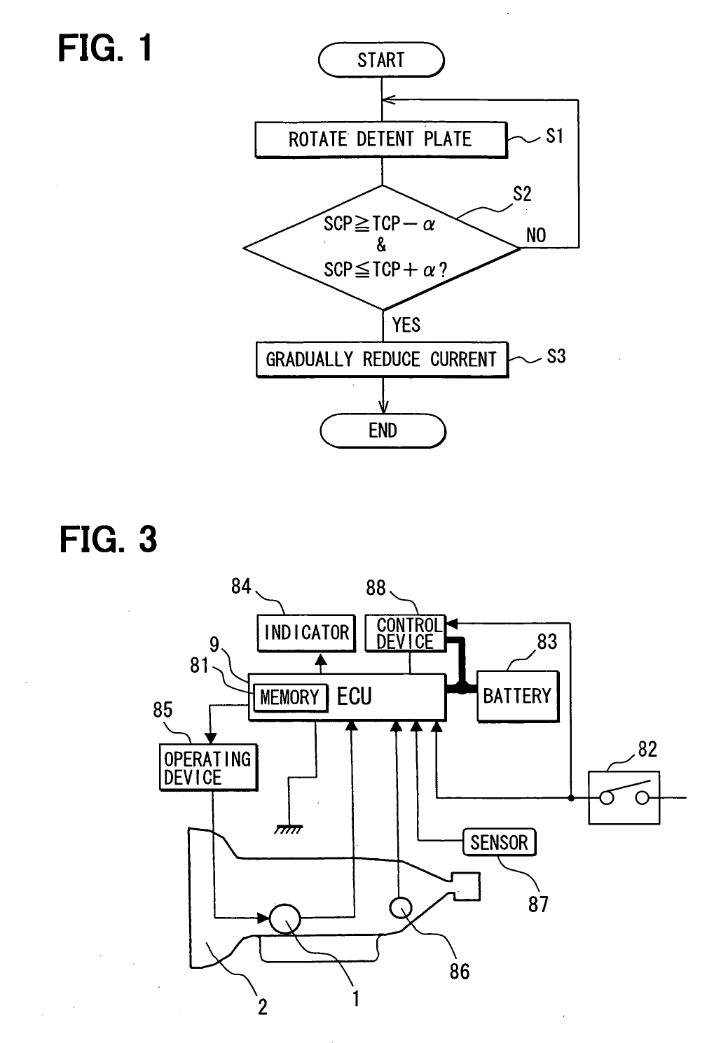

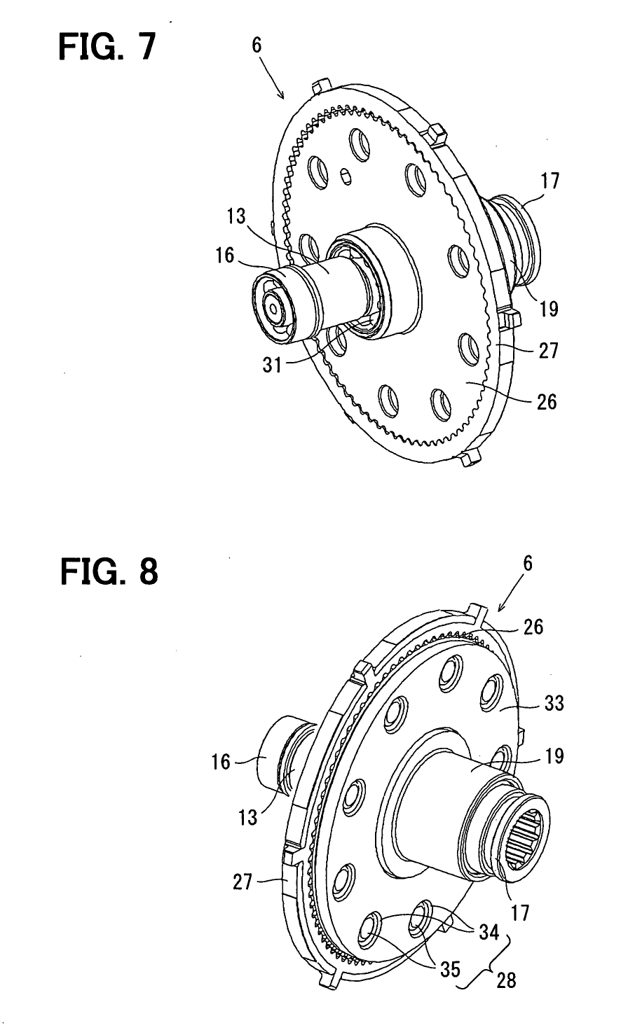

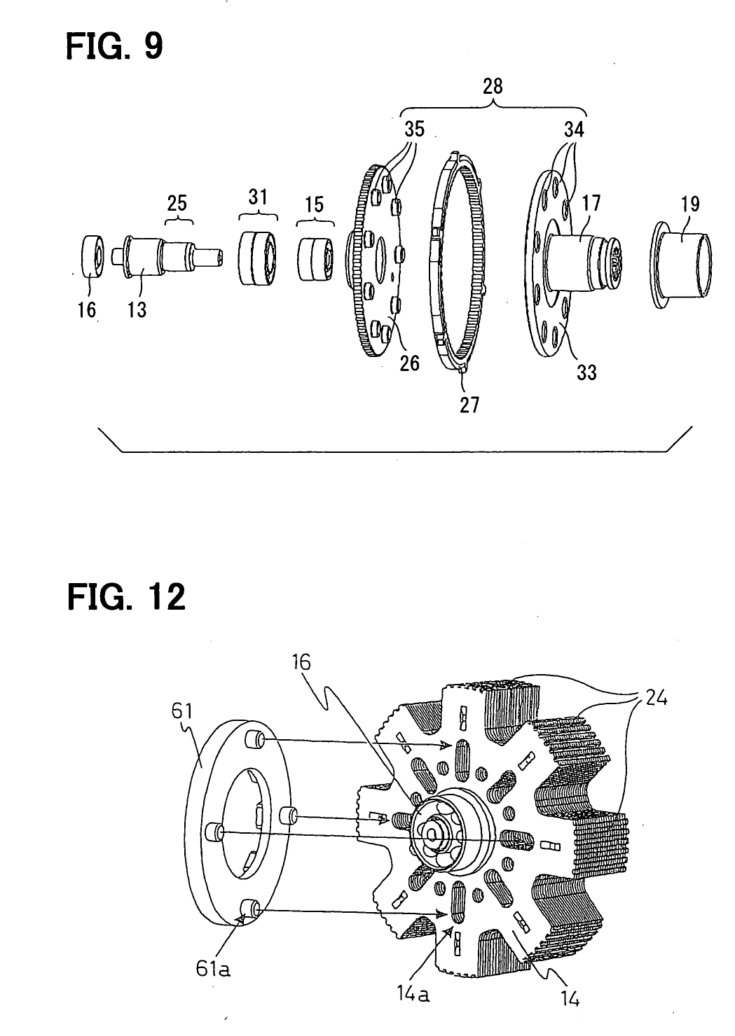

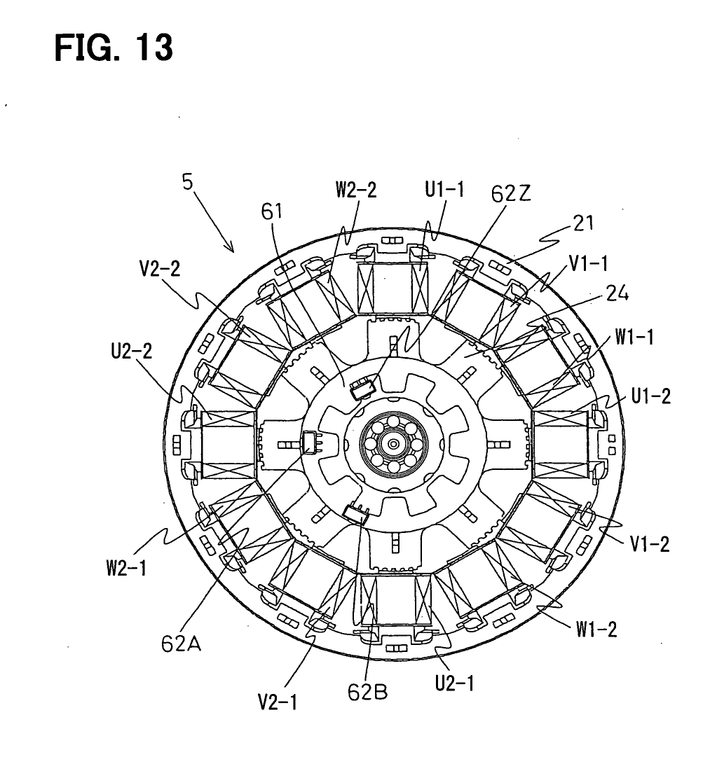

First embodiment will be described with reference to FIG. 1 to FIGS. 20A and 20B.

In first embodiment, the present invention is applied to a shift-range-switching device of an automatic transmission for a vehicle. First, a shift-range-switching device will be described.

(Description of Shift Range Changing Device)

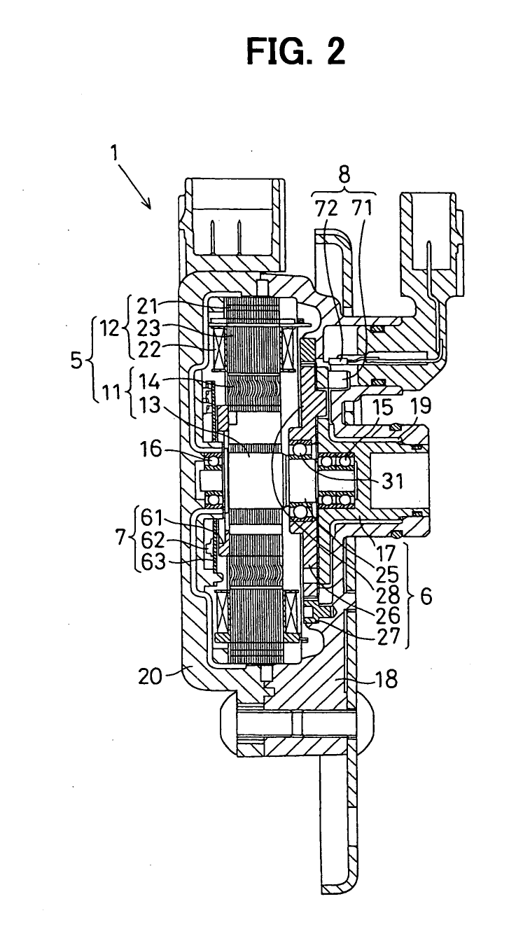

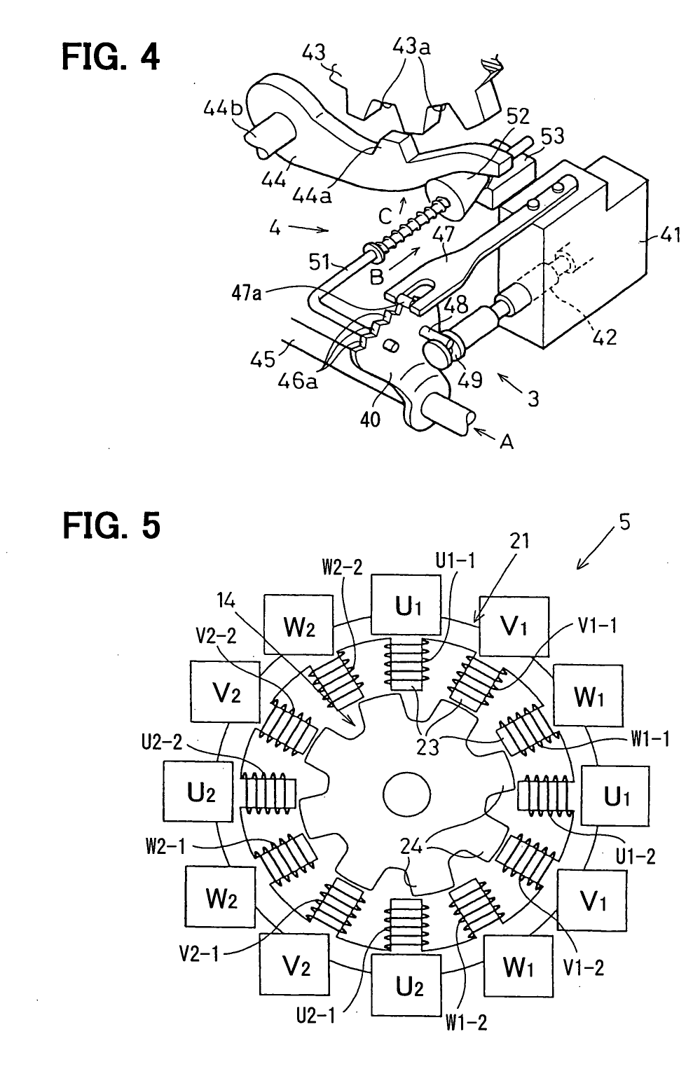

The shift-range-switching device switches a shift-range-switching mechanism 3 (including a parking switching mechanism 4: refer to FIG. 4) mounted on an automatic transmission 2 for a vehicle (refer to FIG. 3) by an electrically operated actuator 1 (refer to FIG. 2) developing a rotational output.

The electrically operated actuator 1 is a servo mechanism for driving the shift-range-switching mechanism 3 and includes a synchronous electric motor 5, a reduction gear 6 for reducing the rotational output of this electric motor 5 to drive the shift-range-switching mechanism 3, an encoder 7 for detecting the rotational angle of the electric motor 5, and output angle detecting means 8 for detecting the output angle of the reduction gear 6 (rotational angle of an output shaft 17 to be described later), and the electric motor 5 for driving the shift-range-switching mechanism 3 via the reduction gear 6 is controlled by an ECU (electric control unit, which is one example of control means) 9.

That is, the shift-range-switching device controls the rotational direction, the number of revolutions, and the rotational angle of the electric motor 5 by the ECU 9 to switch and control the shift-range-switching mechanism 3 driven via the reduction gear 6 to thereby switch an actual range position in the automatic transmission 2.

Hereinafter, this first embodiment will be described with right side in FIG. 2 referred to as a front side and with left side referred to as a rear side.

(Description of Electric Motor 5)

The electric motor 5 will be described with reference to FIG. 2 and FIG. 5. The electric motor 5 of this first embodiment is a blushless SR motor (switched reluctance motor) not using a permanent magnet and a rotatably supported rotor 11 and a stator 12 arranged coaxially with the rotational center of this rotor 11.

The rotor 11 is constructed of a rotor shaft 13 and a rotor core 14, and the rotor shaft 13 is rotatably supported by roller bearings (front roller bearing 15 and rear roller bearing 16) arranged at the front end and rear end of the rotor shaft 13.

In this regard, the front roller bearing 15 is fitted in and fixed to the inside periphery of the output shaft 17 of the reduction gear 6 and the output shaft 17 of the reduction gear 6 is rotatably supported by a metal bearing 19 arranged on the inside periphery of a front housing 18. In other words, the front end of the rotor shaft 13 is rotatably supported via the metal bearing 19 provided in the housing 18, the output shaft 17, and the front roller bearing 15.

Here, a supporting range in the axial direction of the metal bearing 19 is provided so as to overlap a supporting range in the axial direction of the front roller bearing 15. This construction makes it possible to avoid the rotor shaft 13 from being inclined by the reactive force of the reduction gear 6 (specifically, the reactive force of load applied to a portion where a sun gear 26 is engaged with a ring gear 27, which will be described later).

Meanwhile, the rear roller bearing 16 is pressed onto and fixed to the rear outside periphery of the rotor shaft 13 and is supported by a rear housing 20.

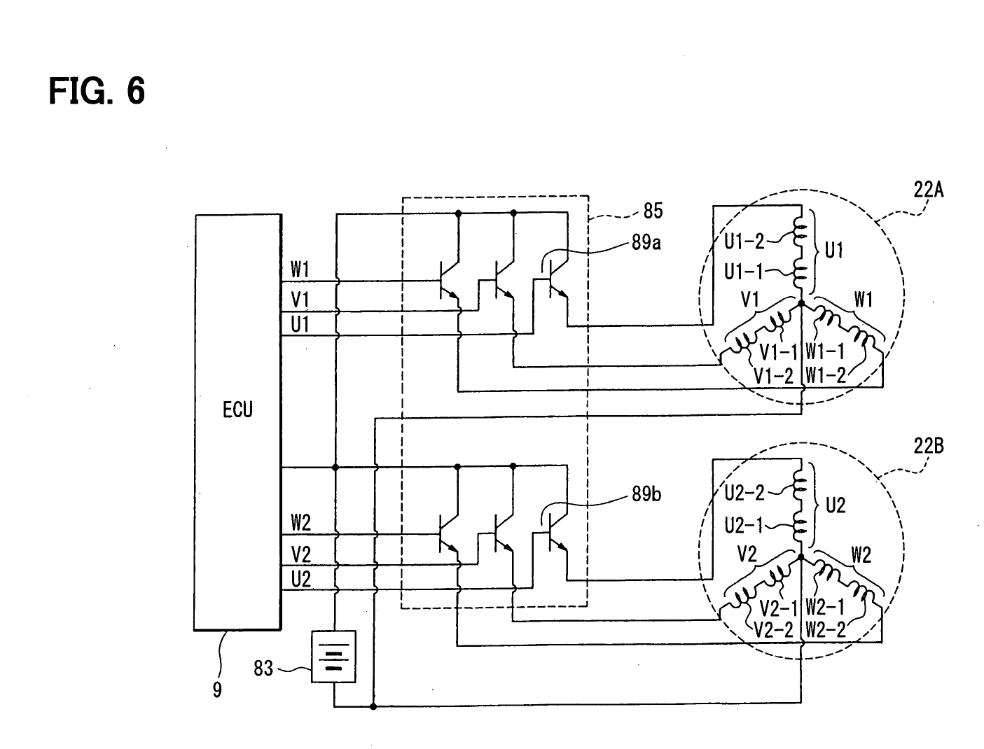

The stator 12 is constructed of a fixed stator core 21 and a plurality of exciting coils of different phases for generating magnetic forces when energized (specifically, coils U1, V1, W1 of a first magnetic circuit 22A and coils U2, V2, W2 of a second magnetic circuit 22B: refer to FIG. 5 and FIG. 6).

The stator core 21 is formed by laminating many thin plates and is fixed to the rear housing 20. This stator core 21 is provided with stator teeth 23 (electrodes protruding inward) formed at intervals of 30 degrees in a manner protruding toward an inside rotor core 14. The coils U1, V1, W1 of the first magnetic circuit 22A and the coils U2, V2, W2 of the second magnetic circuit 22B, each of which generates magnetic force for each of the stator teeth 23, are wound around the stator teeth 23. Here, the coils U1, U2 have a U phase, the coils V1, V2 have a V phase, and the coils W1, W2 have a W phase.

Here, the exciting coil 22 will be described in detail with reference to FIG. 5 and FIG. 6.

In the exciting coil 22, as shown in FIG. 6, the coils U1, V1, W1 of the first magnetic circuit 22A and the coils U2, V2, W2 of the second magnetic circuit 22B are wound around the stator teeth 23 electrically independently of each other and are connected to each other in a star. With a construction to be described below, the rotor 11 can be rotated only by controlling current passing through the coils U1, V1, W1 of the first magnetic circuit 22A or only by controlling current passing through the coils U2, V2, W2 of the second magnetic circuit 22B.

Each of the coils U1, V1, W1 of the first magnetic circuit 22A and the coils U2, V2, W2 of the second magnetic circuit 22B is divided into a plurality of portions (two portions in this embodiment) and is wound around each of the stator teeth 23.

Specifically, the coils U1, V1, W1 of the first magnetic circuit 22A are constructed of “a first set of coils U1-1, V1-1, W1-1,” which are wound around stator teeth 23 connected to each other sequentially in a rotational direction, and “a second set of coils U1-2, V1-2, W1-2,” which are wound around stator teeth 23 connected next to this first set of coils in a manner connected to each other sequentially in the rotational direction.

Then, the coils U2, V2, W2 of the second magnetic circuit 22B are constructed of “a first set of coils U2-1, V2-1, W2-1,” which are wound around stator teeth 23 connected to each other sequentially in the rotational direction, and “a second set of coils U2-2, V2-2, W2-2,” which are wound around stator teeth 23 connected next to this first set of coils in a manner connected to each other sequentially in the rotational direction.

Then, when the respective exciting coils 22 are energized, they develop inverse magnetic poles for each set in the rotational direction. That is, when they are energized, for example, in the case where the internal ends of “the first set of coils U1-1, V1-1, W1-1” develop N magnetic poles, the internal ends of “the second set of coils U1-2, V1-2, W1-2” adjacent to them develop S magnetic poles and the internal ends of “the first set of coils U2-1, V2-1, W2-1” adjacent to them develop N magnetic poles and the internal ends of “the second set of coils U2-2, V2-2, W2-2” adjacent to them develop S magnetic poles.

With this, for example, when two coils U1-1 and U1-2 are energized, the inside diameter portion of one stator tooth 23 (one of two stator teeth 23 at positions 900 apart in the rotational direction) having the coil U1-1 wound thereon develops an N magnetic pole and the inside diameter portion of the other stator tooth 23 having the coil U1-2 wound thereon develops an S magnetic pole. Then, the coils V1, W1, U2, V2, and W2 of the other phases similarly develop inverse magnetic poles at two stator teeth 23 at positions 900 apart in the rotational direction. Their descriptions will be omitted.

The rotor core 14 is formed by laminating many thin plates, and is pressed onto and fixed to the rotor shaft 13. This rotor core 14 has rotor teeth 24 (outward protrusions) protruding toward the stator core 21 of the outside periphery at intervals of 45 degrees.

Then, by sequentially switching positions and directions in which the respective exciting coils 22 of the U phase, the V phase, and the W phase are energized, the stator teeth 23 magnetically attracting the rotor stator 24 are switched in sequence to rotate the rotor 11 in one direction or in the other direction.

(Description of Reduction Gear 6)

The reduction gear 6 will be described with reference FIG. 2 and FIG. 7 to FIG. 9. The reduction gear 6 in this first embodiment is an internally engaged planetary gear reducer (cycloid reducer), which is a kind of planetary gear reducer, and includes a sun gear 26 (inner gear: external gear) mounted in such a way as to be able to eccentrically rotate with respect to a rotor shaft 13 via an eccentric part 25 provided in the rotor shaft 13, a ring gear 27 (outer gear: internal gear) with which this sun gear 26 is internally engaged, and transmission means 28 for transmitting only the rotating component of the sun gear 26 to the output shaft 17.

The eccentric portion 25 is a shaft that eccentrically rotates with respect to the rotary center of the rotor shaft 13 to rotate the sun gear 26 in an oscillatory manner and rotatably supports the sun gear 26 via a sun gear bearing 31 arranged on the outside periphery of the eccentric part 25.

The sun gear 26, as described above, is rotatably supported with respect to the eccentric portion 25 of the rotor shaft 13 via the sun gear bearing 31 and is so constructed as to be rotate by the rotation of the eccentric portion 25 in a state where the sun gear 26 is pressed onto the ring gear 27.

The ring gear 27 is fixed to the front housing 18.

The transmission means 28 is constructed of a plurality of internal pin holes 34 formed on the same circumference of a flange 33 rotating integrally with the output shaft 17 and a plurality of internal pins 35 formed on the sun gear 26 and fitted with play in the respective internal pin holes 34.

The plurality of internal pins 35 are fixed to the front surface of the sun gear 26 in a protruding manner.

The plurality of internal pin holes 34 are formed in the flange 33 fixed to the rear end of the output shaft 17 and the internal pins 35 are fitted in the internal pin holes 35 to transmit the rotating motion of the sun gear 26 to the output shaft 17.

With this construction, when the rotor shaft 13 rotates, the sun gear 26 eccentrically rotates in a speed reduced with respect to the rotor shaft 13 and the reduced rotation of the sun gear 26 is transmitted to the output shaft 17. Here, the output shaft 17 is coupled to a control rod 45 (which will be described later) of a shift-range-switching mechanism 3.

In this regard, unlike this first embodiment, it is also recommendable to form the plurality of internal pins holes 34 in the sun gear 26 and to fix the plurality of internal pins 35 to the flange 33.

(Description of Shift-Range-Switching Mechanism 3)

The shift-range-switching mechanism 3 will be described with reference to FIG. 4. The shift-range-switching mechanism 3 (including a parking switching mechanism 4) is switched and driven by the output shaft 17 of the above-mentioned reduction gear 6.

The switching of the respective shift ranges (for example, P, R, N, D) in the automatic transmission 2 is performed by sliding and displacing a manual spool valve 42 mounted on a hydraulic valve body 41 according to a shift range position to switch a hydraulic pressure supply passage to a hydraulic clutch (not shown) of the automatic transmission 2 to control the engaging state of the hydraulic clutch.

Meanwhile, the locking and unlocking of the parking switching mechanism 4 is performed by engaging or disengaging the depressed portions 43a of a parking gear 43 with or from the protruding portion 44a of the parking pole 44. Here, the parking gear 43 is coupled to the output shaft of the automatic transmission 2 via a drive shaft (not shown), a differential gear (not shown), and the like and by regulating the rotation of the parking gear 43, the driving wheel of a vehicle is locked, whereby a state is achieved in which the parking of the vehicle is locked.

The switching of the respective shift ranges in the automatic transmission 2 and the locking and unlocking of the parking switching mechanism 4 is performed by turning a detent plate 46 fixed to a control rod 45 driven by the reduction gear 6. This detent plate 46 is nearly shaped like a fan and is fixed to the control rod 45 when a spring pin or the like (not shown) is put in.

The shift-range-switching mechanism 3 is provided with a detent mechanism 40 for holding the turning position of the detent plate 46 at any one of the respective shift ranges.

The detent mechanism 40 of this embodiment is constructed of a detent plate 46 (corresponding to a first member) having a plurality of detent grooves 46a relating to the respective shift ranges and a detent spring 47 (corresponding to a second member) that is made of a plate spring and is provided on its tip with an engaging part 47a to be fitted in any one of the detent grooves 46a and this detent spring 47 is fixed to the hydraulic valve body 41.

Here, the plurality of detent grooves 46a are the depressed portions of an uneven portion formed at the tip (arc-shaped portion nearly shaped like a fan) in the radial direction of the detent plate 46 and the engaging part 47a at the tip of the detent spring 47 is fitted in the detent groove 46a to hold the switched shift range.

The detent plate 46 is mounted with a pin 48 for driving a manual spool valve 42.

The pin 48 is engaged with a groove 49 formed at the end of the manual spool valve 42 and when the detent plate 46 is turned by the control rod 45, the pin 48 is driven along an arc to linearly move the manual spool valve 42 engaged with the pin 48 in the hydraulic valve body 41.

When the control rod 45 is turned clockwise when viewed from the direction shown by an arrow A in FIG. 4, the pin 48 presses the manual spool valve 42 into the hydraulic valve body 41 via the detent plate 46, whereby an oil passage in the hydraulic valve body 41 is switched in order of D→N→R→P. In other words, the shift range of the automatic transmission 2 is switched in order of D→N→R→P.

When the control rod 45 is turned in an opposite direction, the pin 48 pulls the manual spool valve 42 out of the hydraulic valve body 41, whereby the oil passage in the hydraulic valve body 41 is switched in order of P→R→N→D. In other words, the shift range of the automatic transmission 2 is switched in order of P→R→N→D.

Meanwhile, the detent plate 46 is fitted with a parking rod 51 for driving a parking pole 44. A conical part 52 is fitted on the tip of this parking rod 51.

This conical part 52 is interposed between the protruding portion 53 of the housing of the automatic transmission 2 and the parking pole 44. When the control rod 45 is turned clockwise when viewed from the direction shown by the arrow A in FIG. 4 (specifically, shift range is switched from R to P), the parking rod 51 is displaced in the direction shown by an arrow B in FIG. 4 via the detent plate 46 to push up parking pole 44 by the conical part 52. Then, the parking pole 44 is turned around a shaft 44b in the direction shown by an arrow C in FIG. 4 to engage the protruding portion 44a of the parking pole 44 with the depressed portion 43a of the parking gear 43, whereby the parking switching mechanism 4 is brought into a locking state.

When the control rod 45 is rotated in a reverse direction (specifically, shift range is switched from P to R), the parking rod 51 is pulled back in a direction opposite to a direction shown by an arrow B in FIG. 4 to eliminate a force pushing up the parking pole 44. Because the parking pole 44 is always biased in a direction opposite to a direction shown by an arrow C in FIG. 4 by a torsion coil spring (not shown), the protruding portions 44a of the parking pole 44 is disengaged from the depressed portion 43a of the parking gear 43 to set the parking gear 43 free, whereby the parking switching mechanism 4 is brought into an unlocking state.

(Description of Encoder 7)

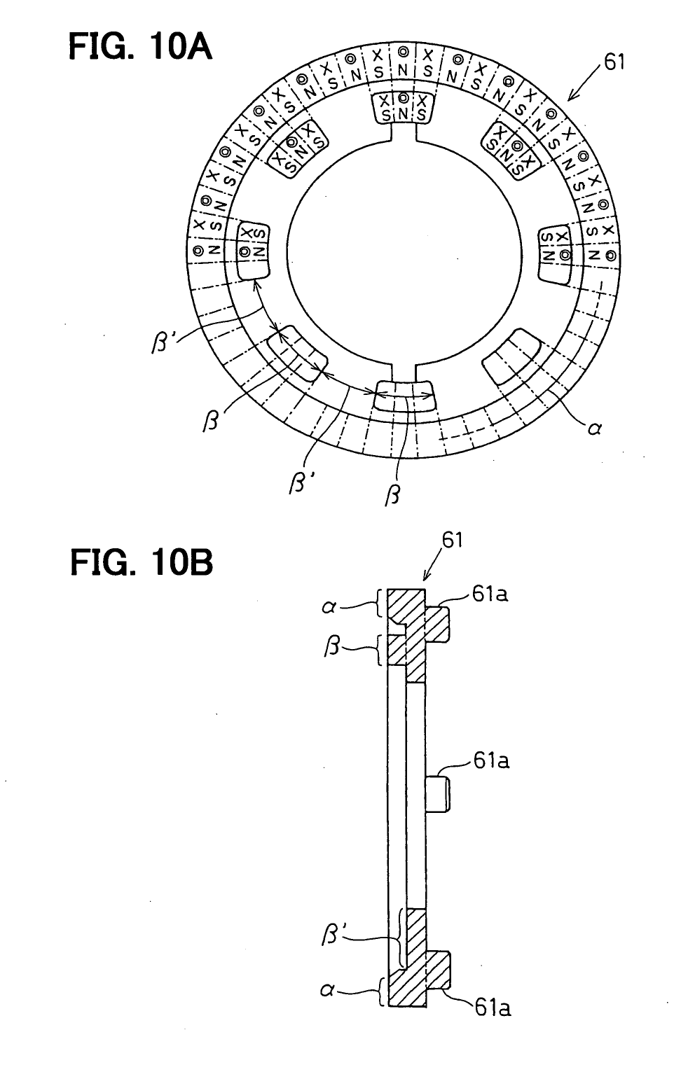

The encoder 7 will be described with reference to FIG. 2, FIGS. 10A, 10B to FIGS. 14A and 14B. The above-mentioned electrically operated actuator 1 has the encoder 7 (rotor angle detecting means) for detecting the rotational angle of the rotor 11 mounted in its housing (front housing 18+rear housing 20). By detecting the rotational angle of the rotor 11 by this encoder 7, the electric motor 5 can be driven at high speeds without a loss of synchronization.

This encoder 7 is of an increment type and is provided with a magnet 61 rotating integrally with the rotor 11 and a magnetism detecting Hall IC 62 arranged in the rear housing 20 (specifically, a Hall IC 62A for a first rotational angle, a Hall IC 62B for a second rotational angle, and a Hall IC 62Z for index) and this Hall IC 62 is supported by a substrate 63 arranged in the rear housing 20.

The magnet 61, as shown in FIGS. 10A and 10B to FIG. 12, is nearly shaped like a ring disc and is arranged coaxially with the rotor shaft 13 and is bonded to the end surface (rear surface) in the axial direction of the rotor core 14. Then, when the rotor core 14 has a large magnetic effect on the magnet 61, to reduce the magnetic effect, the magnet-61 is bonded to the rotor core 14 via a non-magnetic film (not shown).

Then, when the rotor core 14 has a little magnetic effect on the magnet 61, the magnet 61 is bonded directly to the rotor core 14. This can decrease the number of parts and hence can reduce cost.

A plurality of holes 14a for positioning magnets are formed in the rear surface of the rotor core 14, as shown in FIG. 12. Then, a plurality of protrusions 61a are also fixed to the bonding surface of the magnet 61. Then, the protrusions 61a are fitted in the holes 14a of the rotor core 14 to combine the magnet 61 with the rotor core 14, whereby the magnet 61 is combined coaxially with the rotary center of the rotor core 14.

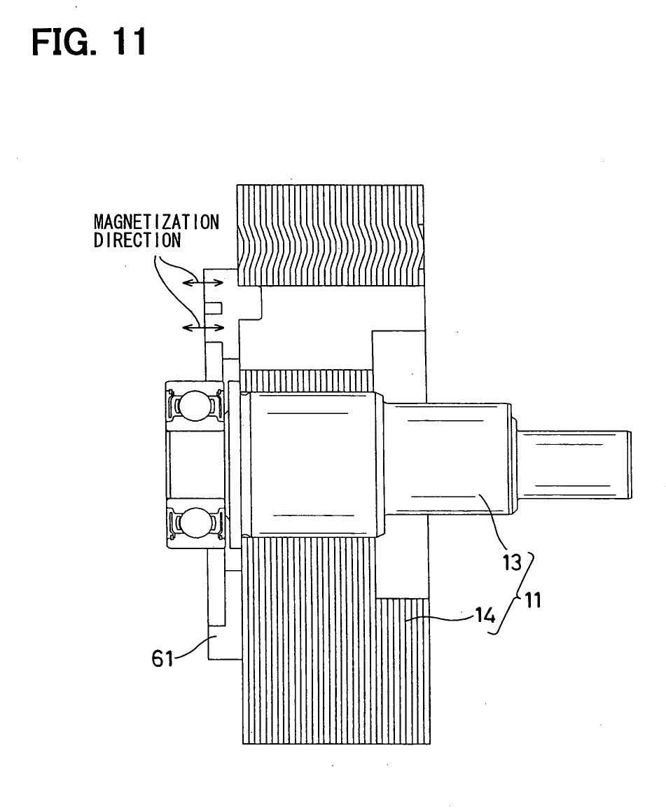

A surface (rear surface) opposite to the Hall IC 62 of the magnet 61, as shown in FIG. 11, is magnetized so as to detect a rotational angle and an index to develop a magnetic force in the axial direction of the magnet 61.

The magnetizing of the surface (rear surface) opposite to the Hall IC 62 will be described with reference to FIGS. 10A and 10B. A rotational angle magnetizing portion α in which multiple magnetic poles for producing/stopping rotational angle signals are developed in a rotary direction are formed on the outer peripheral side of the rear surface of the magnet 61. Then, index magnetizing portions β for producing/stopping index signals and index non-magnetizing portions β′ not relating to the producing of the index signal are formed in the rotational direction adjacently to the internal periphery of the rotational angle magnetizing portions α.

The rotational angle magnetizing portion α is such that is magnetized to develop multiple magnetic poles for producing rotational angle signals (hereinafter referred to as A-phase signal or B-phase signal) in the rotational direction. In the example shown in FIGS. 10A and 10B, N magnetic poles and S magnetic poles are developed repeatedly with a pitch of 7.5 degrees. That is, the rotational angle magnetizing portion α is provided with 48 magnetic poles of A- and B-phase sensing portions.

The index magnetizing portions β are formed for the purpose of producing index signals (hereinafter referred to as Z-phase signals) in the cycle of energizing the exciting coils 22 of the respective phases (U, V, and W phases) one sequence (at intervals of 45 degrees). The index magnetizing portions β are such that are magnetized in such a way as to develop N magnetic poles for producing a Z-phase signal at intervals of 45 degrees and to develop S magnetic poles with a pitch of 7.5 degrees on both sides in the rotational direction of the respective N magnetic poles.

The index non-magnetizing portions β′ are formed between the index magnetizing portion β and index magnetizing portion β (in the rotational direction) and are not magnetized, respectively.

The Hall ICs 62A, 62B for the first and second rotational angles are supported by a substrate 63 in a state opposite to the rotational angle magnetizing portion a in the axial direction. The Hall IC 62Z for index is supported by the substrate 63 in a state opposite to the index magnetizing portion β and the index non-magnetizing portions β′ in the axial direction.

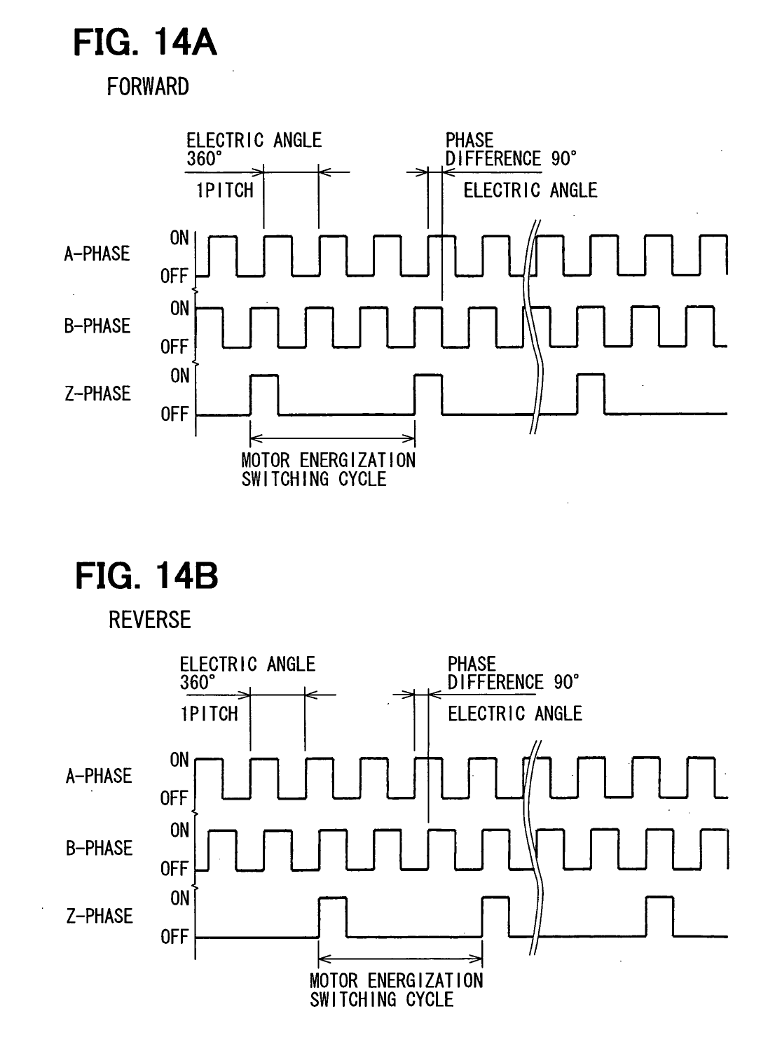

Then, the Hall ICs 62A, 62B for the first and second rotational angles are shifted by 3.75 degrees in relative angle (90 degrees in electric angle). As a result, an A-phase signal and a B-phase signal are shifted from each other by 3.75 degrees in relative angle (90 degrees in electric angle) (refer to FIGS. 14A and 14B).

Each of the Hall ICs 62A, 62B for the first and second rotational angles and the Hall IC 62Z for index is a combination of a Hall device and an ON-OFF signal producing IC. When a Hall device producing an output responsive to the amount of magnetic flux passing therethrough and magnetic flux density on the N-pole side applied to this Hall device exceed thresholds, the Hall device produces a rotational angle signal (A-phase signal, B-phase signal, Z-phase signal) (signal is ON) and when a magnetic flux density on the S-pole side exceeds a threshold, the Hall device stops the rotational angle signal (A-phase signal, B-phase signal, Z-phase signal) (signal is OFF).

In this first embodiment, the Hall IC of a combination of a Hall device and an ON-OFF signal producing circuit (the Hall ICs 62A, 62B for the first and second rotational angles and the Hall IC 62Z for index) has been shown. However, the Hall device and the ON-OFF signal producing circuit may be separately arranged. Specifically, the ON-OFF signal producing circuit may be mounted on the substrate 63 separately from the Hall device or may be mounted in the ECU 9.

Next, the output waveforms of the A-phase signal, the B-phase signal, and the Z-phase signal produced by the encoder 7 will be described by the use of FIGS. 14A and 14B. FIG. 14A shows a situation where the motor rotates in a reverse direction, and FIG. 14B shows a situation where the motor rotates in a forward direction.

The A-phase signal and the B-phase signal are output signals having a phase difference of 3.75 degrees in relative angle (90 degrees in electric angle). The first embodiment is so constructed as to output the A-phase signal and the B-phase signal of one cycle every time the rotor 11 rotates 15 degrees.

The Z-phase signal is an index signal (ON signal in this first embodiment) outputted once every time the rotor 11 rotates 45 degrees and for switching the energizing of the motor. The relative position relationship between a phase for energizing the electric motor 5 and the A phase and the B phase can be defined by this Z-phase signal.

The substrate 63 supports the Hall ICs 62A, 62B for the first and second rotational angles in a state opposite to the rotational angle magnetizing portion a in the axial direction and supports the Hall IC 62Z for index in a state opposite to the index magnetizing portions β and the index non-magnetizing portions β′ in the axial direction. The substrate 63 is fixed to the side surfaces on the rear sides of the respective exciting coils 22 and is arranged in the rear housing 20.

As described in this first embodiment, the encoder 7 is mounted in the electrically operated actuator 1 and hence the electrically operated actuator 1 mounted with the encoder 7 can be reduced in size. Then, this first embodiment has a structure in which the magnet 61 and the Hall ICs 62 are arranged on the rear side of the rotor core 14. Therefore, the electrically operated actuator 1 having the encoder 7 built therein can be prevented from being enlarged in size in the radial direction, which can improve ease with which the electrically operated actuator 1 is mounted in a vehicle.

(Description of Output Angle Detecting Means 8)

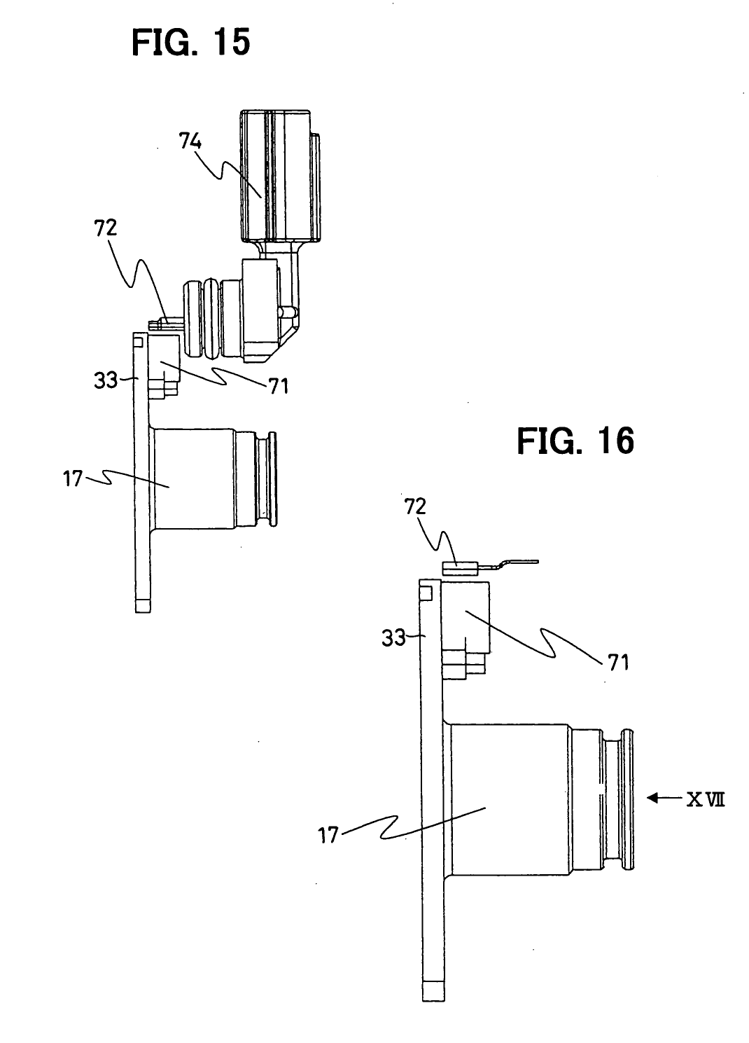

The output angle detecting means 8 will be described with reference to FIG. 15 to FIG. 18. A rotary actuator 1 includes the output angle detecting means 8 for detecting the rotational angle of the output shaft 17 and the ECU 9 detects an actual range position (P, R, N, D) actually set by the shift-range-switching mechanism 3 from the rotational angle of the output shaft 17 detected by the output angle detecting means 8.

This output angle detecting means 8 detects the rotational angle of the output shaft 17 as a continuous amount and is constructed of a magnet 71 fixed to the front surface of the flange 33 rotating integrally with the output shaft 17 and a linear output Hall IC 72.

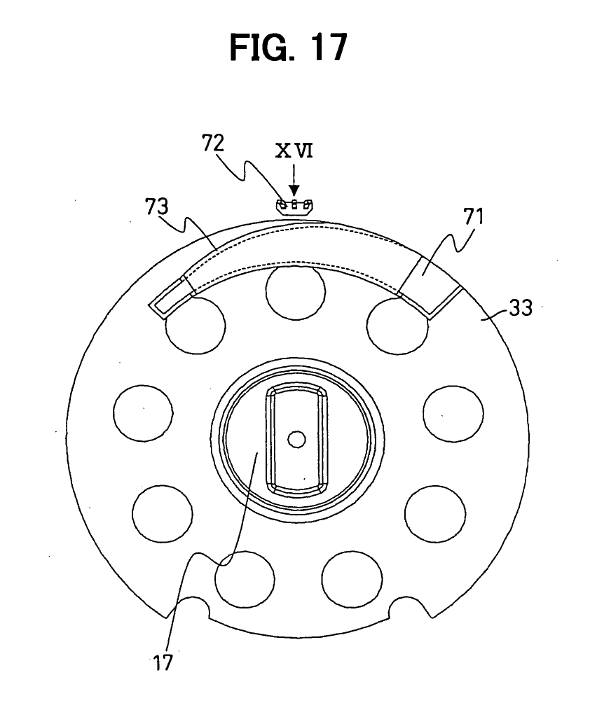

The magnet 71, as shown in FIG. 17, is nearly shaped like a crescent when viewed from the axial direction and is molded with resin 73 and is magnetized in such a way that magnetic flux crosses the linear output Hall IC 72 in the direction shown by an arrow B in FIG. 17. When the distance between the magnet 71 and the linear output Hall IC 72 changes within the rotational range of the output shaft 17 (within a range where the set range of an actual range position changes), the magnetic flux density passing through the linear output Hall IC 72 changes.

Specifically, in this embodiment, the distance between the linear output Hall IC 72 and the magnet 71 becomes maximum (density of magnetic flux passing through the linear output Hall IC 72 becomes minimum) at a position where the output shaft 17 rotates in such a way that an actual range position is on D side and the distance between the linear output Hall IC 72 and the magnet 71 becomes minimum (density of magnetic flux passing through the linear output Hall IC 72 becomes maximum) at a position where the output shaft 17 rotates in such a way that an actual range position is on P side.

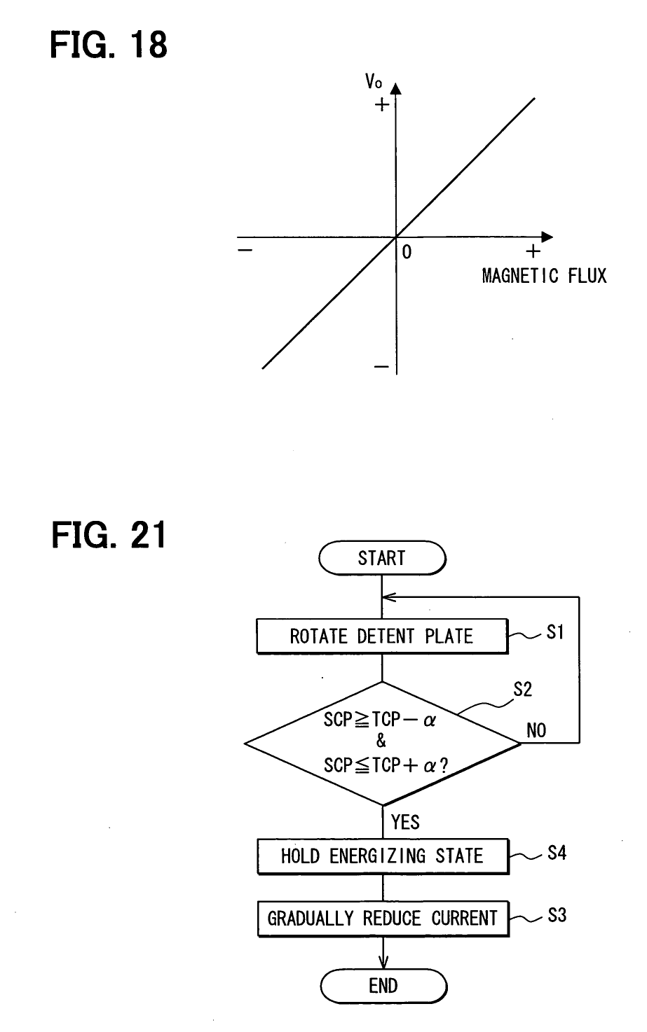

The linear Hall IC 72 is mounted on a connector 74 made of resin and is provided with a Hall device producing an output voltage responsive to the density of magnetic flux passing through the linear output Hall IC 72. As shown in FIG. 18, as the density of magnetic flux passing through the linear output Hall IC 72 becomes larger, so the output voltage produced by the linear output Hall IC becomes larger.

That is, by reading the output voltage of the linear output Hall IC 72, the rotational angle of the output shaft 17 and an actual range position can be detected from the output voltage.

(Description of ECU 9)

The ECU 9 will be described with reference to FIG. 3.

The ECU 9 for controlling the energizing of the electric motor 5 is a microcomputer having a well-known structure constructed of a CPU for performing control processing and operation processing, storage means 81 for storing various programs and data (ROM, memory such as SRAM, EEPROM, RAM capable of storing data even when energizing is stopped), an input circuit, an output circuit, a power supply circuit, and the like.

Here, a reference symbol 82 in FIG. 3 denotes a startup switch (ignition switch, accessory switch, or the like), a reference symbol 83 denotes a vehicle-mounted battery, a reference symbol 84 denotes display means for showing the states of a shift range and the electrically operated actuator 1 (visual display, alarm lamp, alarm sound in a normal operation), a reference symbol 85 denotes the coil driving circuit of the electric motor 5, a reference symbol 86 denotes a vehicle speed sensor, a reference symbol 87 denotes the setting switch (or detecting sensor) of manual range setting means manually operated by an occupant, a brake switch for detecting whether or not a vehicle braking device for applying a braking force to wheels is applied, and the other sensors for detecting the state of the vehicle.

Then, a reference symbol 88 denotes a control device relating to a vehicle door such as an electrically operated slide door, an electrically operated trunk opener, and the like.

While an example in which the coil driving circuit 85 is mounted separately from the ECU 9 is shown in FIG. 3, the coil driving circuit 85 may be built in the case of the ECU 9.

The coil driving circuit 85 will be described with reference to FIG. 6. The electric motor 5, as described above, is constructed of the first magnetic circuit 22A (coils U1, V1, W1) and the second magnetic circuit 22B (coils U2, V2, W2) that are electrically independent of each other, and the coils U1, V1, and W1 of the first magnetic circuit 22A and the coils U2, V2, and W2 of the second magnetic circuit 22B are connected in a star, respectively.

Then, the coil driving circuit 85 is constructed of a first switching device 89a for supplying power to the respective phases (coils U1, V1, W1) of the first magnetic circuit 22A and a second switching device 89b for supplying power to the respective phases (coils U2, V2, W2) of the second magnetic circuit 22B, and when the ECU 9 turns on or off the first and second switching devices 89a, 89b, the energizing states of the respective coils U1, V1, W1, U2, V2, W2 are switched.

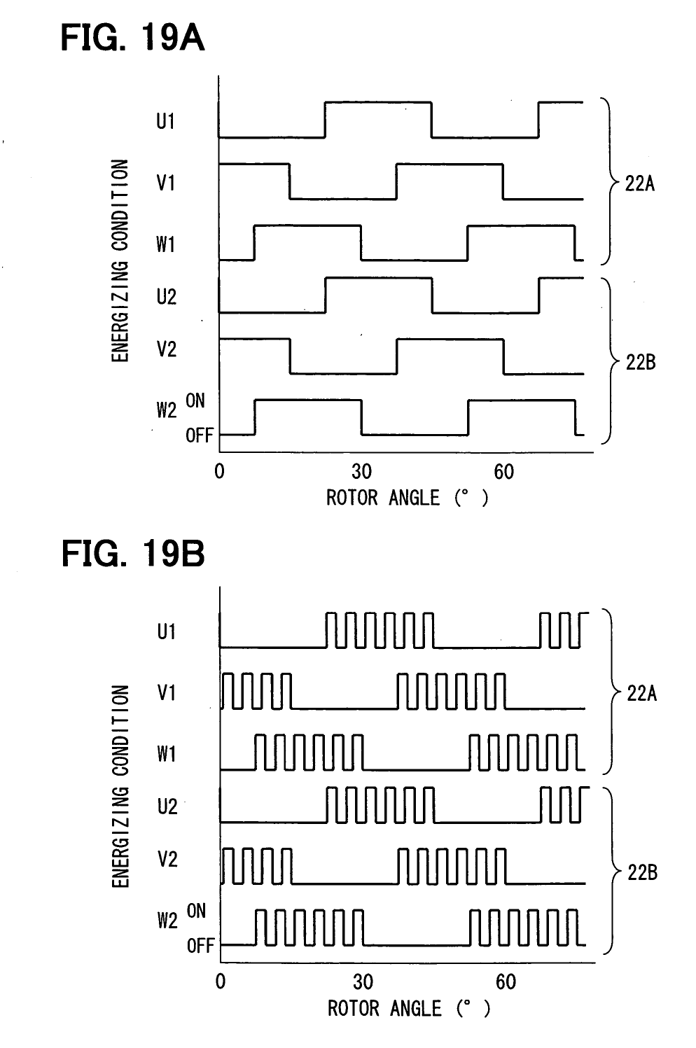

When the rotor 11 is rotated (which corresponds to a normal control operation), as shown in FIG. 19A, the ECU 9 turns on or off the first and second switching devices 89a, 89b on the basis of the rotational angle of the rotor 11 detected by the encoder 7 and the correction term of delay in excitation (by open control in some case) to switch the state of energizing the respective exciting coils 22 in sequence to rotate the rotor 11.

The ECU 9 is provided with various programs such as “rotor angle reading means” for reading the rotational speed, the number of revolutions, the rotational angle of the rotor 11 from the outputs of the encoder 7 (the Hall ICs 62A and 62B for the first and second rotational angles and the Hall IC 62Z for index), “output reading means” for reading the rotational angle of the output shaft 17 from the output of the output angle detecting means 8 (output of the linear output Hall IC 72), and “normal control means” for controlling the electric motor 5 such that a manual range position set by the manual range setting means agrees with an actual range position recognized by the ECU 9.

“The normal control means” is a control program for performing the following action: when there is a range difference between a manual range position set by the manual range setting means and an actual range position read by a rotational angle detected by the output angle detecting means 8, “the normal control means” determines the rotational direction, the number of evolutions, and the rotational angle of the electric motor 5 on the basis of the range difference and controls phases for energizing the respective exciting coils 22 on the basis of that determination to control the rotational direction, the number of evolutions, and the rotational angle of the electric motor 5 to thereby cause the manual range position set by the manual range setting means to agree with the actual range position recognized by the ECU 8 and then stops energizing the electric motor 5.

The normal control means of the ECU 9, as described above, performs controlling the switching of the shift range and then stops energizing the electric motor 5.

Meanwhile, the detent mechanism 40 for holding the detent plate 46 in the shift-range-switching mechanism 3, as described above, is constructed of the detent plate 46 having the plurality of detent grooves 46a relating to the respective shift ranges (which corresponds to the first member) and the detent spring 47 (which corresponds to the second member) made of a plate spring and having an engaging part 47a fitted in any one of the detent grooves 46a formed at its tip. In this detent mechanism 40, when the engaging part 47a at the tip of the detent spring 47 is fitted in the detent groove 46a, a switched shift range is held.

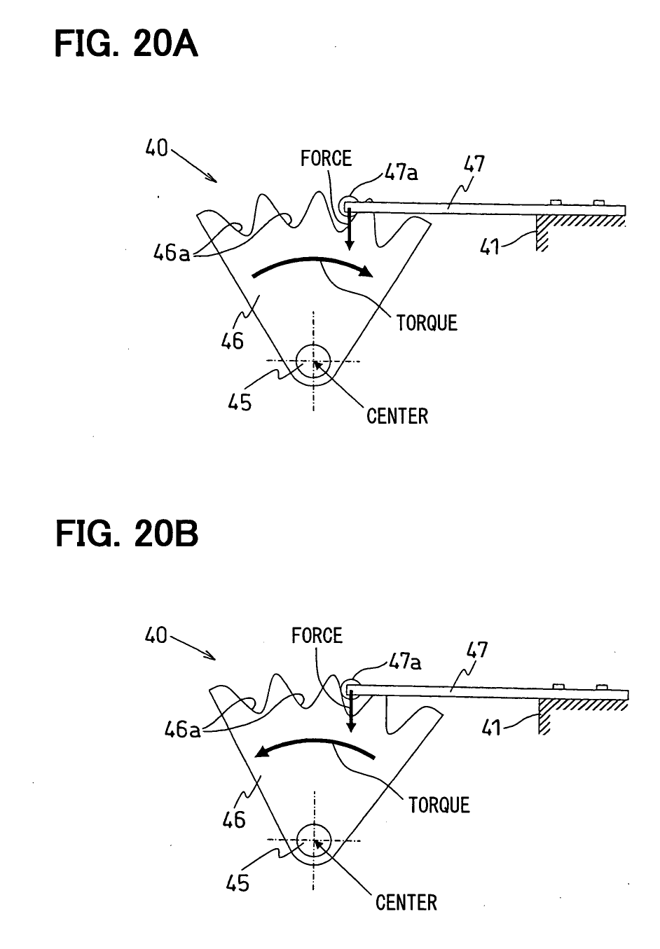

An uneven shape forming the respective detent grooves 46a, as shown in FIGS. 20A and 20B, is formed by a curve so as to allow the detent mechanism 40 to be released from engagement when the detent plate 46 is driven. Then, the engaging part 47a of the detent spring 47 is so constructed as to be pressed in a direction toward the bottom of the detent grooves 46a (in a direction toward the rotational center of the detent plate 46) by the biasing force of the detent spring 47 and hence applies a mechanical force to the detent plate 46 in such a way as to move the engaging part 47a toward the lowest bottom portion of the detent groove 46a in a state where the engaging part 47a deviates from the lowest bottom portion of the detent groove 46a.

A specific example will be described with reference to FIGS. 20A and 20B.

As shown in FIG. 20A, in a state where a position where the engaging part 47a abuts against the detent groove 46a deviates from the lowest bottom portion of the detent groove 46a to D range side (right side in the drawing), a mechanical force for turning the detent plate 46 clockwise in the drawing is produced by the spring force of the detent spring 47.

On the contrary, as shown in FIG. 20B, in a state where a position where the engaging part 47a abuts against the detent groove 46a deviates from the lowest bottom portions of the detent groove 46a to P range side (left side in the drawing), a mechanical force for turning the detent plate 46 counterclockwise in the drawing is produced by the spring force of the detent spring 47.

Therefore, for the ECU 9 to prevent the detent plate 46 from changing in position after finishing switching the shift range and then stopping energizing the electric motor 5 in the electrically operated actuator 1, the ECU 9 needs to cause “the drive/control stopping position,” where controlling the switching of the shift range is finished and where energizing the electrically operated actuator 1 is stopped completely, to agree with “a detent stabilizing position” where the detent mechanism 40 is stably stopped.

However, various mechanical parts constructing the shift-range-switching apparatus have individual variations caused in a manufacturing process. Therefore, it is difficult to cause the mechanical “detent stabilizing position” to completely agree with the electric “drive/control stopping position.”

Here, when “the drive/control stopping position” deviates from “the detent stabilizing position” because of mechanical variations and the like, just before energizing the electric motor 5 is stopped (in a state where the electric motor 5 is energized at the drive/control stopping position), the detent mechanism 40 stopped in a state where “torque for stopping drive and control” produced by the electrically operated actuator 1 balances with “a restoring spring force” for moving the detent plate 46 to “the detent stabilizing position.” When energizing the electrically operated actuator 1 is stopped in this state, “the torque for stopping drive and control” and “the restoring spring force” are thrown out of balance to swing the detent plate 46 across a position where the detent mechanism 40 is stable by the action of inertial moment and the restoring spring force. This swing of the detent plate 46 causes the malfunction of displacing also the manual spool valve 42.

Then, to avoid the above-mentioned malfunction, first embodiment employs the following means.

(I) The detent plate 46 (first member) and the detent spring 47 (second member) can move relatively and the detent plate 46 is mechanically held (in other words, shift range is mechanically held) by the detent mechanism 40 in which the engaging part 47a is fitted in the detent groove 46a.

(II) The detent plate 46 is driven by the electrically operated actuator 1.

(III) The ECU 9 controls the energizing of the electrically operated actuator 1 (specifically, electric motor 5) to drive and control the turning position of the detent plate 46 (shift range position).

(IV) The ECU 9 has the function of “energizing stopping means” that performs “torque reducing control” of reducing the output torque of the electrically operated actuator 1 as compared with a normal driving operation and then stops energizing the electrically operated actuator 1 when the turning position of the detent plate 46 reaches “a drive/control stopping position” and hence energizing the electrically operated actuator 1 is stopped at the time of controlling the switching of the shift range.

(V) “Torque reducing control” in first embodiment gradually reduces power supplied to the electrically operated actuator 1 by duty control, as shown in FIG. 19B.

“The energizing stopping means” is a control program executed when switching the shit range is finished by the above-mentioned “normal control means.”

The control example of this “energizing stopping means” will be described with reference to a flow chart in FIG. 1.

When the instruction of switching a shift range is provided (START), the phase of current passing through the electrically operated actuator 1 is controlled in such a way that the actual rotational angle of the detent plate 46 (actual rotational angle of the output shaft 17 detected by the output angle detecting means 8 or the encoder 7) becomes a target rotational angle computed by the ECU 9 to thereby turn the detent plate 46 (Step S1).

Next, it is determined whether or not the actual rotational angle of the output shaft 17 detected by the output angle detecting means 8 or the encoder 7 (switching control position “SCP” in the drawing) is within the range of “a target rotational angle (target control position “TCP” in the drawing)±α” (Step S2).

When the determination result in this Step S2 is NO, the routine returns to Step S1 and then the Steps S1 and S2 are performed repeatedly until the determination result becomes YES.

When the determination result in Step S2 is YES (“actual rotational angle” is within the range of “the target rotational angle±α”: that is, the turning position of the detent plate 46 reaches “drive/control stopping position”), as shown in FIG. 19B, the first and second switching devices 89a, 89b are switched by duty control to perform energizing the respective exciting coils 22 (coils U1, V1, W1, U2, V2, W2) by duty control to perform torque reducing control for gradually reducing the amount of current passing through the respective exciting coils 22 (the amount of current per unit time) and then energizing the electrically operated actuator 1 is stopped (Step S3), whereby this shift range switching processing is finished (END).

In this regard, the rate of reducing the amount of current by the duty control (speed for shortening the ON times of the first and second switching devices 89a, 89b in a specified period) is provided previously by a map and the like.

Moreover, the amount of current reduced by the duty control may be reduced continuously or stepwise, or may be reduced continuously and stepwise.

The shift-range-switching apparatus mounted in the above-mentioned manner produces the following effect.

When the actual rotational angle of the output shaft 17 becomes within the range of “a target rotational angle±α” (when the engaging part 47a is fitted in the detent groove 46a within the target range and detent plate 46 reaches “drive/control stopping position”) at the time of controlling the switching of the shift range, by the torque reducing control for energizing stopping means, the torque reducing control that gradually reduces power supplied to the electrically operated actuator 1 by the duty control to gradually reduce the output torque of the electrically operated actuator 1 as compared with the case of normal driving operation is performed, and then energizing the electrically operated actuator 1 is stopped.

With this, the output torque of the electrically operated actuator 1 is gradually reduced before energizing the electrically operated actuator 1 is stopped. Hence, even when “the drive/control stopping position” deviates from “the detent stabilizing position,” “the drive/control stopping torque” and “restoring spring force” are gradually thrown out of balance.

That is, when the detent plate 46 reaches “drive/control stopping position,” the rotational angle of the detent plate 46 is gradually displaced from “the drive/control stopping position” to “the detent stabilizing position” and then energizing the electrically operated actuator 1 is stopped. As a result, after the switching of the shift range is completed, the detent plate 46 does not swing by the action of inertial moment and restoring spring force.

In this manner, after the switching of the shift range is completed, the detent plate 46 is prevented from swinging. Hence, it is possible to shorten time required to stop the detent plate 46 after the switching of the shift range is completed.

Moreover, the manual spool valve 42 can be also prevented from being swung by the swinging of the detent plate 46 after the switching of the shift range is completed. Hence, it is possible to eliminate a malfunction that an oil passage area switched by the manual spool valve 42 varies.

Furthermore, as described above, because the detent plate 46 is prevented from swinging after the switching of the shift range is completed, the electrically operated actuator 1 is not moved by an external force. Hence, it is also possible to expect an effect that the electrically operated actuator 1 is not mechanically damaged.

### Second Embodiment

Second embodiment will be described with reference to FIG. 21. Here, parts shown by the same reference symbols in the following embodiment as in first embodiment denote the same functioning parts.

When the detent plate 46 reaches “the drive/control stopping position” and then energizing the electrically operated actuator 1 is stopped, “the energizing stopping means” in this second embodiment keeps the state of energizing the electrically operated actuator 1 for a specified period of time and then performs the above-mentioned torque reducing control and then stops energizing the electrically operated actuator 1.

The control example of “the energizing stopping means” in second embodiment will be described with reference to a flow chart in FIG. 21. Here, the same control as in FIG. 1 (first embodiment) is denoted by the same reference symbols and their descriptions will be omitted.

In the case where the determination result in Step S2 is YES (“actual rotational angle” is within “target rotational angle±α”), the energizing state of the exciting coil 22 when the determination result in Step S2 is YES (energizing state at the normal driving operation when the actual range position reaches a target range position: refer to FIG. 19A) is held for a specified period of time (Step S4).

Next, in Step S3, energizing the respective exciting coils 22 (coils U1, V1, W1, U2, V2, W2) is performed by duty control (refer to FIG. 19B) to gradually reduce the amount of current passing through the respective exciting coils 22 and then energizing the electrically operated actuator 1 is stopped, whereby this switching processing of the shift range is finished (END).

In this regard, the specified period of time during which the energizing state of the exciting coil 22 is held in Step S4 may be a previously set constant period of time or may be a period of time set according to the rotational speed of the rotor 11 or the output shaft 17 (a period of time set longer as the rotational speed becomes higher) when the determination result in Step S2 becomes YES (when an actual range position reaches a target range position).

The shift-range-switching apparatus constructed in the above-mentioned manner can produce the following effects.

When the actual rotational angle of the output shaft 17 becomes within the range of a target rotational angle±α at the time of controlling the switching of the shift range (detent plate 46 reaches “the drive/control stopping position”), the energizing state at a normal driving operation when the actual rotational angle of the output shaft 17 reaches the target range, is kept for a specified period of time and then the torque reducing control disclosed in first embodiment is performed.

In this manner, by keeping the energizing state of the electrically operated actuator 1 at the energizing state when the actual rotational angle of the output shaft 17 reaches the target range for a specified period of time, the turning position of the detent plate 46 can be moved to a target position with high accuracy.

Moreover, by keeping the energizing state of the electrically operated actuator 1 for a specified period of time before performing the torque reducing control, it is possible to eliminate inertia moment developing in the movable member of the shift-range-switching mechanism in the process of switching the shift range and hence to prevent the detent plate 46 from being swung by the inertia moment in the process of switching the shift range.

### Third Embodiment

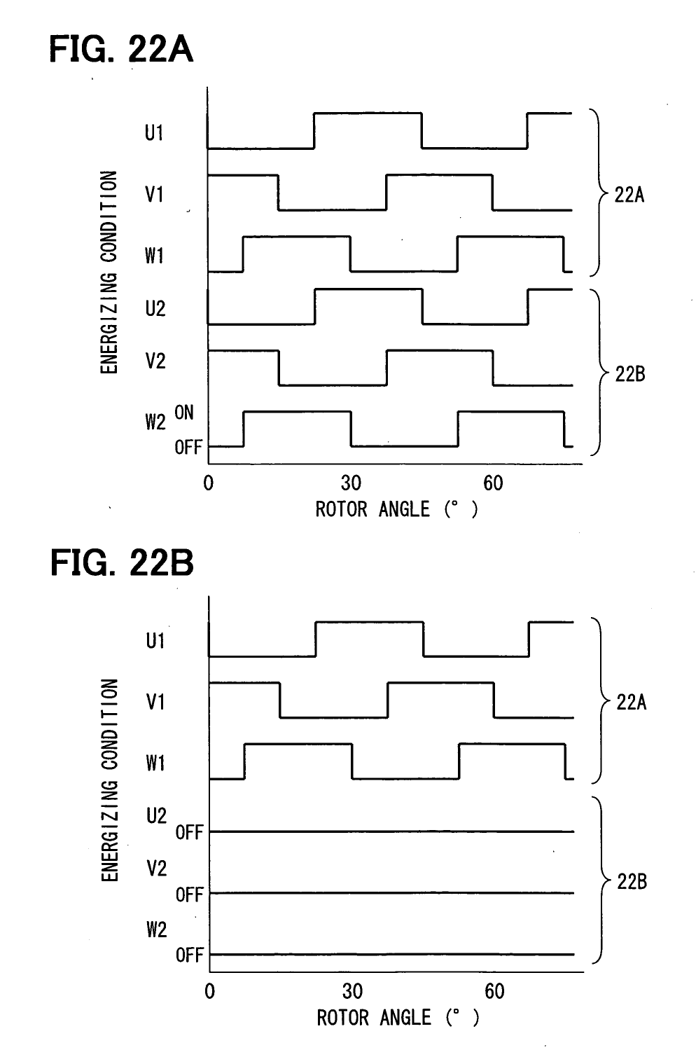

Third embodiment will be described with reference to FIGS. 22A and 22B.

In the above-mentioned first and second embodiments, an example in which energizing the respective exciting coils 22 (coils U1, V1, W1, U2, V2, W2) is performed by duty control to reduce the amount of current passing through the respective exciting coils 22 to thereby reduce the output torque of the electrically operated actuator 1 has been shown as one example of the torque reducing control.

In contrast to this, this third embodiment employs the following means.

(I) The electric motor 5 of the electrically operated actuator 1 includes a plurality of magnetic circuits (the first and second magnetic circuits 22A, 22B) (just as with first embodiment).

Specifically, the electric motor 5, as disclosed in first embodiment (refer to FIG. 6), is constructed of the first magnetic circuit 22A (coils U1, V1, W1) and the second magnetic circuit 22B (coils U2, V2, W2), which are electrically independent of each other, in such a way that only the coils U1, V1, W1 of the first magnetic circuit 22A or only the coils U2, V2, W2 of the second magnetic circuit 22B can be energized by controlling the energizing of the first and second switching devices 89a, 89b.

(II) The ECU 9 energizes the plurality of magnetic circuits of the electrically operated actuator 1 (when the first and second magnetic circuits 22A, 22B) at the same time when the electrically operated actuator 1 is normally driven shift range is switched) (just as with first embodiment: refer to FIG. 22A).

(III) The torque reducing control by the energizing stopping means is to stop the plurality of magnetic circuits in sequence.

Specifically, the energizing states of the magnetic circuits are switched in order of (1) both of the first and second magnetic circuits 22A, 22B are energized, (2) only one of the first and second magnetic circuits 22A, 22B is energized, (3) energizing both of them is stopped.

Specifically, in the above-mentioned (II), as shown in FIG. 22B, only the first switching device 89a is energized to energize only the first magnetic circuit 22A to thereby reduce the output torque of the electrically operated actuator 1.

By constructing the shift range apparatus in the above-mentioned manner, when the actual range position reaches the target range position and the actual rotational angle of the output shaft 17 reaches the target rotational angle (the detent plate 46 reaches “the drive/control stopping position”) at the time of controlling the switching of the shift range, by the torque reducing control by the energizing stopping means, the energizing state of the electrically operated actuator 1 is switched in order of (1) both of the first and second magnetic circuits 22A, 22B are energized, (2) only the first and magnetic circuits 22A is energized, (3) energizing both of them is stopped.

That is, when the detent plate 46 reaches “the drive/control stopping position,” “the drive/control stopping torque” is once reduced and then energizing the electrically operated actuator 1 is stopped.

For this reason, even when “the drive/control stopping position” deviates from “the detent stabilizing position,” there is not brought about an abrupt change in the balance between “the drive/control stopping torque” and “the storing spring force.” Therefore, it is possible to prevent the detent plate 46 from being swung by the action of the inertial moment and the restoring spring force after the switching of the shift range is completed.

[Modifications]

It is also recommendable to combine second embodiment and third embodiment.

That is, when the actual range position reaches the target range position and the turning position of the detent plate 46 reaches “the drive/control stopping position” at the time of controlling the switching of the shift range, it is also recommendable (1) to keep the energizing state of the electrically operated actuator 1 for a specified period of time and then (2) to perform the torque reducing control for stopping the plurality magnetic circuits in sequence.

It is also recommendable to combine first embodiment and third embodiment.

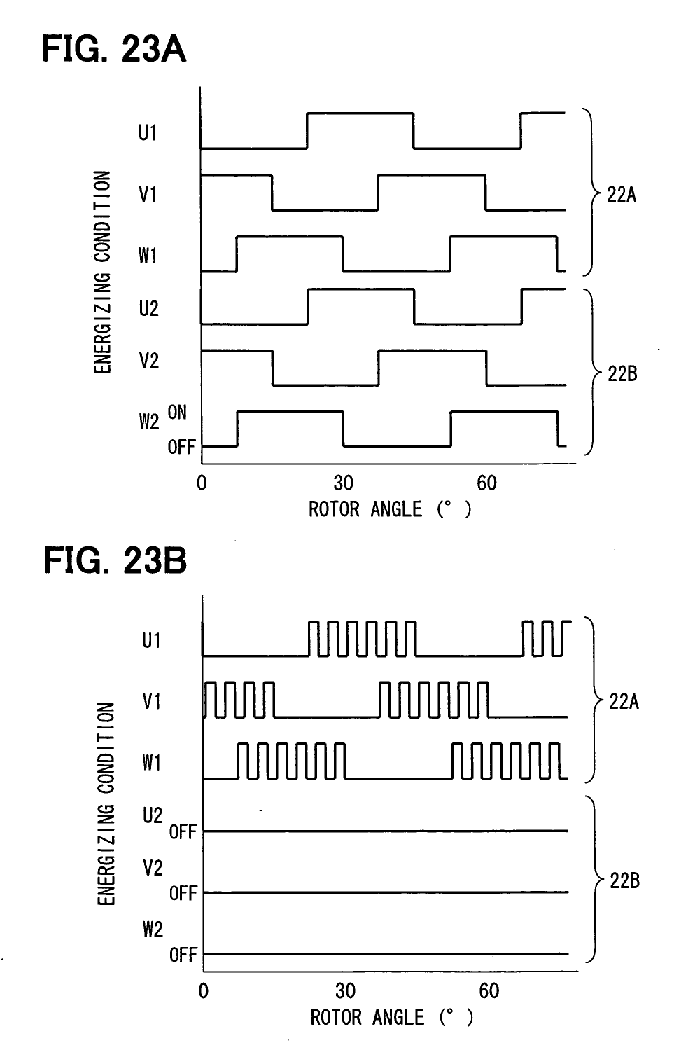

That is, as shown in FIGS. 23A and 23B, it is also recommendable to combine the torque reducing control for gradually reducing power supplied to the electrically operated actuator 1 by duty control and the torque reducing control for stopping the plurality magnetic circuits in sequence.

It is also recommendable to combine first to third embodiments.

That is, when the actual range position reaches the target range position and the turning position of the detent plate 46 reaches “the drive/control stopping position” at the time of controlling the switching of the shift range, it is also recommendable (1) to keep the energizing state of the electrically operated actuator 1 for a specified period of time and then (2) to combine the torque reducing control for gradually reducing power supplied to the electrically operated actuator 1 by duty control and the torque reducing control for stopping the plurality magnetic circuits in sequence.

While examples using the encoder 7 and the output angle detecting means 8 have been shown in the above-mentioned embodiments, it is also recommendable to eliminate either the encoder 7 or the output angle detecting means 8 or to eliminate both of them.

When the encoder 7 is eliminated, it is also recommendable to count the number of operations of energizing the respective exciting coils 22 to control the number of revolutions and the rotational angle of the rotor 11.

When the output angle detecting means 8 is eliminated, it is also recommendable to detect the angle of the output shaft 17 from a value counted by the encoder 7.

When both of the encoder 7 and the output angle detecting means 8 are eliminated, it is also recommendable to count the number of operations of energizing the respective exciting coils 22 to control the number of revolutions and the rotational angle of the rotor 11, and to detect the angle of the output shaft 17 from the number of revolutions and the rotational angle of the rotor 11.

While examples each using an SR motor as one example of the electric motor 5 have been shown in the above embodiments, it is also recommendable to use other motors including other reluctance motor such as a synchronous reluctance motor, permanent magnet type synchronous motor such as a surface magnet structure type synchronous motor (SPM) and a built-in magnet type synchronous motor (IPM), and the like.

While examples each using the electric motor 5 having two magnetic circuits as one example of the electric motor 5 have been shown in the above embodiments, it is also recommendable to use an electric motor having a plurality of (three or more) magnetic circuits. Moreover, when the technology according to claims 1, 2, and 3 is implemented, the shift-range-switching apparatus may be constructed of an electric motor having a single magnetic circuit.

While examples each using the internally engaged planetary gear reducer (cycloid reducer) as one example of the reduction gear 6 have been shown in the above embodiments, it is also recommendable to use a planetary gear reducer of the type constructed of a sun gear 26 driven by the rotor shaft 13, a plurality of planetary pinions arranged at equal intervals around this sun gear 26, and a ring gear engaged with the peripheries of these planetary pinions.

While examples each using the internally engaged planetary gear reducer (cycloid reducer) as one example of the reduction gear 6 have been shown in the above embodiments, it is also recommendable to use a speed reducer constructed of a combination of the sun gear 26 driven by the rotor shaft 13 and a gear train constructed of a plurality of gear trains engaged with this sun gear 26.

While examples each driving a shift-range-switching mechanism 3 by the electrically operated actuator 1 of a combination of the electric motor 5 and the reduction gear 6 (electrically operated actuator 1=electric motor 5+reduction gear 6) have been shown in the above embodiments, it is also recommendable to drive the shift-range-switching mechanism 3 by the electrically operated actuator 1 including only the electric motor 5 (electrically operated actuator 1=electric motor 5).

While examples in which the electrically operated actuator 1 is mounted with the electric motor 5 for producing the rotational output have been shown in the above embodiments, it is also recommendable to employ other actuator operated by electric control such as linear solenoid.

While examples in which the present invention is applied to a shift-range-switching apparatus for driving a shift-range-switching mechanism 3 have been shown in the above embodiments, the present invention can be applied to an apparatus for switching the detent mechanism 40 by the electrically operated actuator 1, for example, an industrial robot using the detent mechanism 40.

What is claimed is:

1. A switching controlling apparatus comprising:
a detent mechanism which includes a first member and a second member that can move relatively to each other, and holds the first and second members mechanically by a structure in which the first and second members are engaged with each other by a spring force;
an electrically operated actuator for driving the first member; and
a control means for controlling an energization of the electrically operated actuator to drive and control the first member,
wherein the control means comprises an energizing stopping means that performs torque reducing control for gradually reducing an output torque of the electrically operated actuator and then stops energization of the electrically operated actuator when the detent mechanism is brought into an engaged state and a driving position of the first member reaches a drive/control stopping position.

2. The switching controlling apparatus according to claim 1, wherein
the energizing stopping means keeps an energizing state of the electrically operated actuator for a specified period of time and performs the torque reducing control when a driving position of the first member reaches the drive/control stopping position and the energization of the electrically operated actuator is stopped.

3. The switching controlling apparatus according to claim 1, wherein
the torque reducing control in the energizing stopping means is control for gradually reducing electric power supplied to the electrically operated actuator by duty control.

4. The switching controlling apparatus according to claim 1, wherein
the control means energizes a plurality of magnetic circuits of the electrically operated actuator concurrently at the time of normally driving the electrically operated actuator, and
the torque reducing control in the energizing stopping means is a control for stopping the plurality of magnetic circuits in sequence.

5. The switching controlling apparatus according to claim 1, wherein
the electrically operated actuator is comprised of a combination of an electric motor for developing a rotational output when energized and a reduction gear for reducing the output of the electric motor.

6. The switching controlling apparatus according to claim 1, wherein
the electrically operated actuator drives a shift-range-switching mechanism mounted on an automatic transmission for a vehicle, and
the detent mechanism is a mechanism for holding a set position of a shift range in the shift-range-switching mechanism.
